(19) United States
(12) Patent Application Publication
(10) Pub. No.: US 2014/0237216 A1
(43) Pub. Date: Aug. 21, 2014

(54) MICROPROCESSOR

(71) Applicant: Casio Computer Co., Ltd., Tokyo (JP)

(72) Inventor: Masato Soshi, Tokyo (JP)

(73) Assignee: CASIO COMPUTER CO., LTD., Tokyo (JP)

(21) Appl. No.: 14/158,491

(22) Filed: Jan. 17, 2014

(30) Foreign Application Priority Data
Feb. 20, 2013 (JP) 2013-031095

(51) Int. Cl. G06F 9/30

(52) U.S. Cl. CPC G06F 9/3001
USPC 712/221

(57) ABSTRACT

A microprocessor according to an aspect of the present invention includes an arithmetic operation unit. The arithmetic operation unit includes: a plurality of arithmetic operation devices arranged in a multi-stage arrangement; a delay device provided to each stage of the arithmetic operation devices excluding a final stage, and configured to delay an arithmetic operation result of the arithmetic operation devices for one cycle; and a selector provided to each stage of the arithmetic operation devices excluding the final stage, and configured to select either the arithmetic operation result of the arithmetic operation devices or the arithmetic operation result delayed for one cycle in the delay device and output the selected result to the arithmetic operation device in a next stage. The microprocessor is configured to collectively process a plurality of arithmetic operations from the arithmetic operation unit by controlling a selecting condition in the selector.

### CROSS-REFERENCE TO RELATED APPLICATIONS

This application claims the benefit of priority from prior Japanese Patent Application No. 2013-031095, filed on Feb. 20, 2013, the entire contents of which are incorporated herein by reference.

### BACKGROUND

1. Technical Field

The present invention relates to a microprocessor suitable for executing an extended instruction in pipeline processing.

2. Related Art

A microprocessor in the related art has processed four arithmetic operations or a logical operation in one instruction. A recent microprocessor can collectively process a plurality of arithmetic operations in one instruction. This makes it possible to increase the processing amount which can be processed in one cycle and to decrease the total number of processing cycles. However, when an operation frequency makes it difficult to process one instruction in one cycle, that is, when processing time is not within the one cycle because of the configuration of an arithmetic operation circuit, an execution cycle of the processor is temporarily stalled and the processing is executed in a plurality of cycles, as shown in FIG. 11.

In FIG. 11, (A) shows an operation clock of a CPU, and as shown in (B), the case of executing one instruction in seven stages in total, that is, in seven cycles, will be given as an example. The seven stages are an instruction fetch stage IF, an instruction decode stage ID, instruction execution stages EX1 to EX3, a memory access stage MEM, and a register write back stage WB.

Among all the stages, the three cycles of the instruction execution stages EX1 to EX3, are the stages to execute the instruction. As shown in (C) to (E) of FIG. 11, an arithmetic operation is executed according to the values loaded in registers r1, r2, and r3, and the arithmetic operation result is stored in the register r3.

In the case of an electronic device used by changing the operation frequency of the processor, it is necessary to determine the number of execution cycles according to the maximum frequency, assuming the case of using the electronic device at the maximum frequency.

In FIG. 12, (A) shows a CPU clock having a much lower frequency than the operation clock shown in (A) of FIG. 11, and (B) of FIG. 12 shows the case of executing an arithmetic operation by pipeline processing in the CPU clock. Inversely proportional to the frequency, the time of one cycle t12 becomes longer than the time of one cycle t11 shown in (A) of FIG. 11. Therefore, in the arithmetic operation circuit, there is a case, for example, where the arithmetic operation processing which needs the time of three cycles in FIG. 11 can be executed in two cycles. However, even in this case, the processing is executed in three cycles because of the operation control of the CPU.

Thus, when the processor operates at a low clock frequency, even if processing can be executed in fewer cycles, the processing has to be executed in as many cycles as the operation at a high clock frequency. As a result, the number of processing cycles is increased and the processing speed is decreased.

By the way, there is a technique proposed to provide a pipeline processor capable of improving reliability without increasing complexity, although the purpose thereof is not for solving the above problem (see, for example, JP 2007-034731 A).

This patent technique includes an instruction decoder unit, a core instruction execution unit, an extended instruction execution unit, and a re-order buffer. The instruction decoder unit selectively issues either a core instruction in which the number of instruction execution cycles is fixed or an extended instruction defined by a user. The core instruction execution unit executes the issued core instruction. The extended instruction execution unit executes the issued extended instruction. The re-order buffer temporarily stores the instruction execution results of each of the core instruction execution unit and the extended instruction execution unit, sorts the instruction execution results in the issuance order of the core instructions and the extended instructions, and outputs the sorted results.

### SUMMARY

A microprocessor according to an aspect of the present invention includes an arithmetic operation unit. The arithmetic operation unit includes: a plurality of arithmetic operation devices arranged in a multi-stage arrangement; a delay device provided to each stage of the arithmetic operation devices excluding a final stage, and configured to delay an arithmetic operation result of the arithmetic operation devices for one cycle; and a selector provided to each stage of the arithmetic operation devices excluding the final stage, and configured to select either the arithmetic operation result of the arithmetic operation devices or the arithmetic operation result delayed for one cycle in the delay device and output the selected result to the arithmetic operation device in a next stage. The microprocessor is configured to collectively process a plurality of arithmetic operations from the arithmetic operation unit by controlling a selecting condition in the selector.

### BRIEF DESCRIPTION OF THE DRAWINGS

FIG. 1 is a block diagram showing a hardware configuration of a microprocessor according to an embodiment of the present invention;

FIG. 2 is a diagram showing a block configuration for processing an instruction in a CPU according to the embodiment;

FIG. 3 is a block diagram showing a configuration of a second arithmetic logic unit in the CPU according to the embodiment;

FIG. 4 is a table showing contents of processing corresponding to each of the levels, L level and H level, of select signals A and B, in the second arithmetic logic unit according to the embodiment;

FIG. 5 is a diagram showing a first program example according to the embodiment;

FIG. 6 is a timing chart showing contents of processing of the second arithmetic logic unit during execution of the first program according to the embodiment;

FIG. 7 is a diagram showing a second program example according to the embodiment;

FIG. 8 is a timing chart showing contents of processing of the second arithmetic logic unit during execution of the second program according to the embodiment;

FIG. 9 is a diagram showing a third program example according to the embodiment;

FIG. 10 is a timing chart showing contents of processing of the second arithmetic logic unit during execution of the third program according to the embodiment;

FIG. 11 is a timing chart of a general microprocessor executing an instruction in a plurality of cycles, when an operation clock has a high frequency; and

FIG. 12 is a timing chart of a general microprocessor executing an instruction in a plurality of cycles, when an operation clock has a low frequency.

### DETAILED DESCRIPTION

In the following, a microprocessor according to an embodiment of the present invention will be described with reference to the drawings.

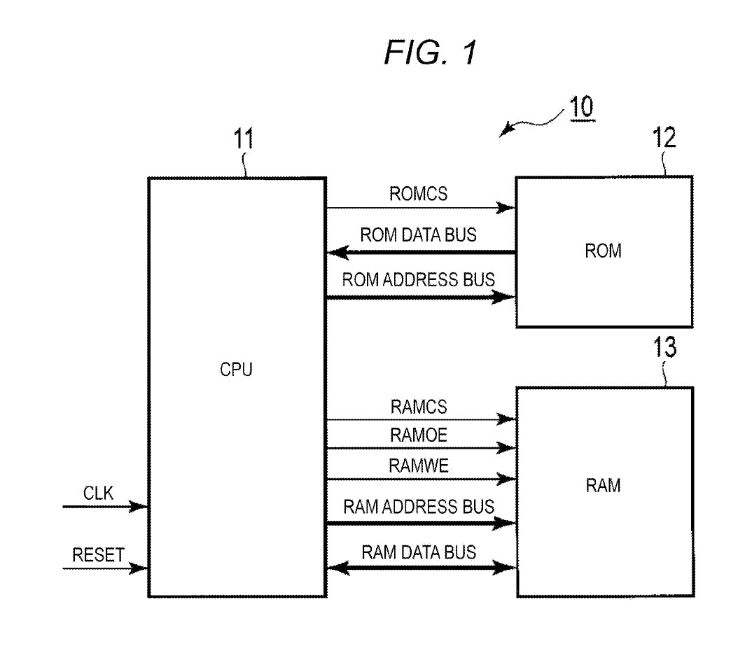

FIG. 1 is a block diagram showing a function circuit configuration of a microprocessor 10 according to the embodiment. In FIG. 1, a CPU 11 is connected to a ROM 12 and a RAM 13. The CPU 11 is a microprocessor to execute processing. The ROM 12 is a program memory storing an instruction code. The RAM 13 is a work memory.

A system clock CLK and a reset signal RESET are given externally to the CPU 11. The CPU 11 outputs a chip select signal ROMCS to the ROM 12, and also specifies the address of the ROM 12 through a ROM address bus. In this manner, the CPU 11 reads a program instruction stored in the address through a ROM data bus.

In addition, the CPU 11 outputs a chip select signal RAMCS, a reading signal RAMOE, and a writing signal RAMWE to the RAM 13, and also specifies the address of the RAM 13 through a RAM address bus. In this manner, the CPU 11 writes/reads data to/from the address through a RAM data bus.

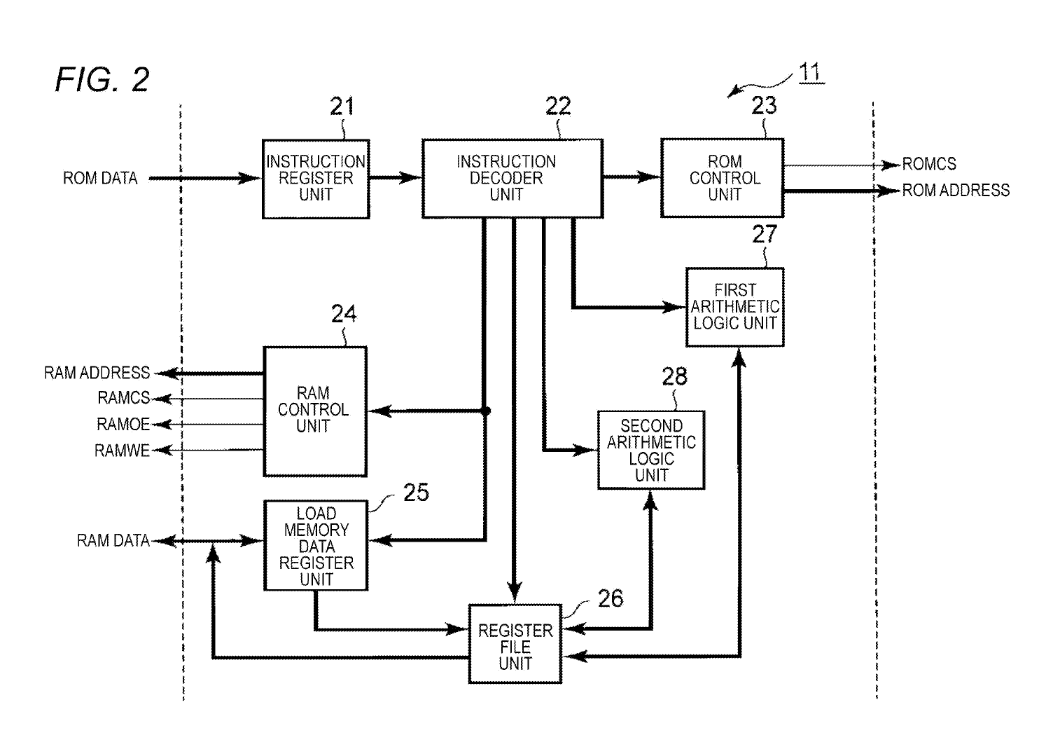

FIG. 2 is a diagram showing a block configuration for executing a program in the CPU 11. In FIG. 2, the instruction read from the ROM 12 through the ROM data bus is input to and retained in an instruction register unit 21.

An instruction decoder unit 22 reads and decodes the instruction retained in the instruction register unit 21, and outputs the decoded result to a ROM control unit 23. According to the decoded result, the instruction decoder unit 22 appropriately controls a RAM control unit 24, a load memory data register unit 25, a register file unit 26, a first arithmetic logic unit 27, and a second arithmetic logic unit 28.

The ROM control unit 23 outputs the chip select signal and the ROM address to the ROM 12.

The RAM control unit 24 specifies the address of the RAM 13 through the RAM address bus, and also outputs the chip select signal RAMCS, the reading signal RAMOE, and the writing signal RAMWE, to the RAM13.

The load memory data register unit 25 and the register file unit 26 are connected to the RAM 13 through the RAM data bus, output the retained data to the RAM 13, and retain the data output from the RAM 13.

While sending data to the register file unit 26 and receiving data therefrom according to the control by the instruction decoder unit 22, the first arithmetic logic unit 27 executes a specified arithmetic operation, such as normal four arithmetic operations and a logical operation, and outputs the operation result to the register file unit 26.

While sending data to the register file unit 26 and receiving data therefrom according to the control by the instruction decoder unit 22, the second arithmetic logic unit 28 executes an arithmetic operation added by the extended instruction, and outputs the arithmetic operation result to the register file unit 26.

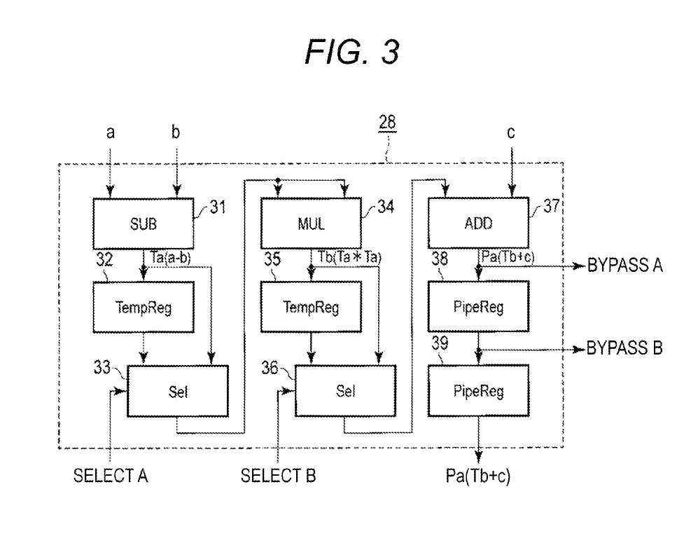

Next, a specific configuration example in the second arithmetic logic unit 28 will be described with reference to FIG. 3. Here, the second arithmetic logic unit 28 as a circuit to execute an arithmetic operation:

(a−b)*(a−b)+c (1)

will be described as an example.

To execute the arithmetic operation, a subtractor, a multiplier, and an adder are the necessary arithmetic operation devices. Therefore, as shown in FIG. 3, a subtractor 31, a multiplier 34, and an adder 37 are arranged in a multi-stage arrangement.

The subtractor 31 receives numerical values corresponding to the variables a and b in the equation (1) from the register file unit 26, and executes the subtraction “a−b”. Then, the subtractor 31 outputs the obtained difference Ta to a temporary register 32 and a selector 33. The temporary register 32 functions as a delay device, and reads the contents Ta retained for one cycle into the selector 33.

According to a select signal A given by the register file unit 26, the selector 33 selects either the difference Ta output from the subtractor 31 or the contents Ta retained in the temporary register 32, and outputs the selected one in parallel, to the multiplier 34 in the next stage.

The multiplier 34 executes a multiplication “Ta*Ta”, according to the output from the selector 33. Then, the multiplier 34 outputs the obtained product Tb to a temporary register 35 and a selector 36. The temporary register 35 functions as a delay device, and reads the contents Tb retained for one cycle into the selector 36.

According to a select signal B given by the register file unit 26, the selector 36 selects either the product Tb output from the multiplier 34 or the contents Tb retained in the temporary register 35, and outputs the selected one to the adder 37 in the next stage.

The adder 37 receives a numerical value corresponding to a variable c in the equation (1) from the register file unit 26, and executes an arithmetic operation “Tb+c” corresponding to the equation (1) by using the input numerical value together with the output Tb output from the selector 36. While directly outputting the obtained arithmetic operation result Pa as a bypass A output, the adder 37 also outputs the obtained arithmetic operation result Pa to a pipeline register 38.

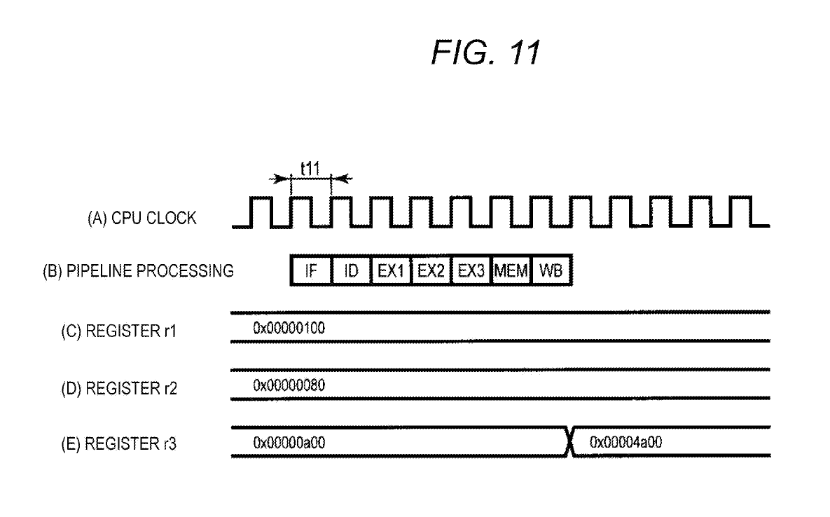

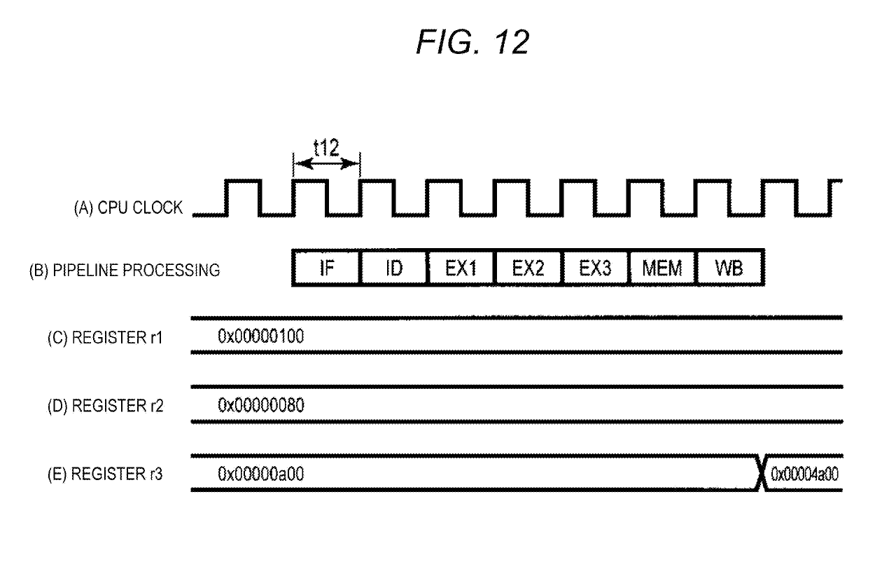

The pipeline register 38 retains and delays the result calculated in instruction execution stages (EX1 to EX3 in FIG. 11) of pipeline processing, in the next stage; a register write back stage (WB in FIG. 11). After retaining the arithmetic operation result Pa output from the adder 37, the pipeline register 38 directly outputs the arithmetic operation result Pa as a bypass B output, and also outputs the arithmetic operation result Pa to a pipeline register 39 configured like the pipeline register 38.

After retaining the arithmetic operation result Pa output from the pipeline register 38, the pipeline register 39 outputs the arithmetic operation result Pa to the register file unit 26.

Since the calculated result cannot be used in the next instruction after written into the pipeline registers 38 and 39 in the register write back stage (WB in FIG. 11), each of the bypass A output and the bypass B output performs a bypass output of the data of the calculated result, which is the data before written into the registers. The bypass A output enables the data to be used in an instruction execution stage (EX in FIG. 11) of the next instruction, and the bypass B output enables the data to be used in an instruction execution stage (EX in FIG. 11) of the instruction after the next.

Next, as an operation of the embodiment, an operation especially in the second arithmetic logic unit 28 of the microprocessor 10 will be described.

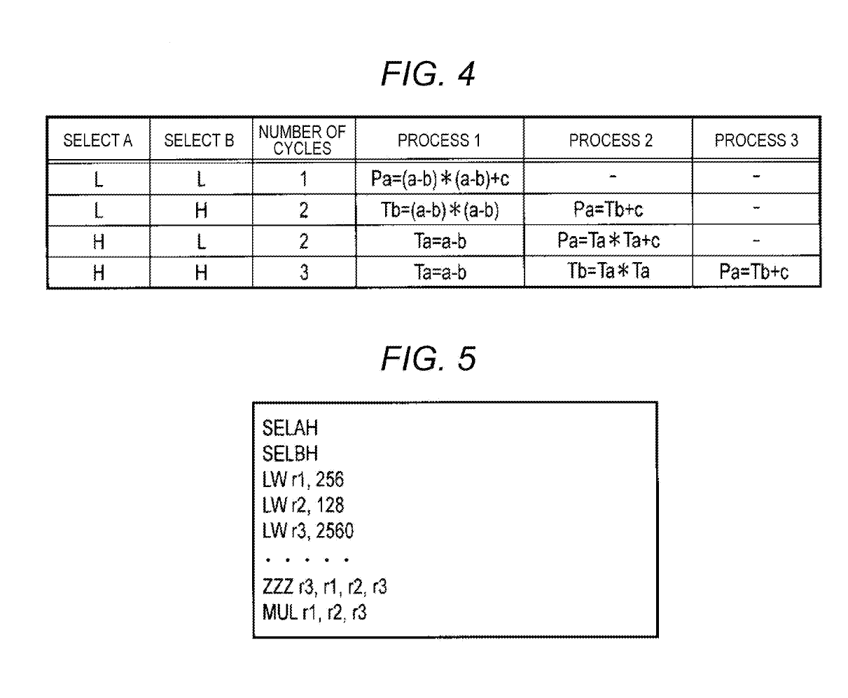

FIG. 4 is a table showing contents of processing corresponding to each of the levels, L level and H level, of the select signals A and B, in the second arithmetic logic unit 28. When the select signal A is at the L level, the selector 33 selects the output Ta output from the subtractor 31. When the select signal A is at the H level, the selector 33 selects the arithmetic operation result Ta delayed for one cycle in the temporary register 32. Then, the selector 33 outputs the selected one to the multiplier 34.

Likewise, when the select signal B is at the L level, the selector 36 selects the output Tb output from the multiplier 34. When the select signal B is at the H level, the selector 36 selects the arithmetic operation result Tb delayed for one cycle in the temporary register 35. Then the selector 36 outputs the selected one to the adder 37.

Thus, by switching L/H of the select signals A and B as shown in FIG. 4, the number of processing cycles in the second arithmetic logic unit 28 can be changed among one to three.

In the following, operation examples for variably controlling the number of processing cycles will be described.

### FIRST OPERATION EXAMPLE

FIG. 5 is a diagram showing a first program example. In the program, “SELAH” is an instruction to set the select signal A for the selector 33 at the H level, and “SELBH” is an instruction to set the select signal B for the selector 36 at the H level.

An “LW” instruction is an instruction for loading immediate data into a register. Here, values “256”, “128” and “2560” are loaded into the registers r1 r2, and r3, respectively.

A “ZZZ” instruction is an additional instruction to be executed in the second arithmetic logic unit 28. If “ZZZ r3, r1, r2, r3”, the instruction is inserted into the equation (1), and an arithmetic operation:

r3=(r1−r2)*(r1−r2)+r3

is executed.

A “MUL” instruction is a simple multiplication instruction, which is executed in the first arithmetic logic unit 27. If “MUL r1, r2, r3”, an arithmetic operation:

r1=r2*r3

is executed.

In the case of this program, as described above, the select signal A is specified to be at the H level, and the select signal B to be at the H level. Therefore, as shown in FIG. 4, the instruction execution stage EX of the “ZZZ” instruction becomes three cycles.

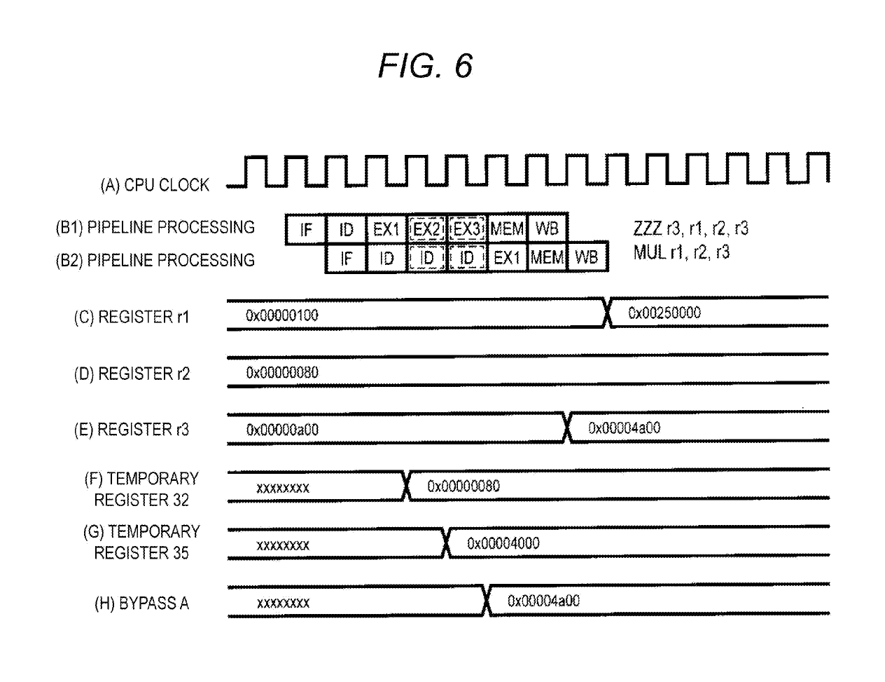

FIG. 6 is a timing chart showing contents of processing in the second arithmetic logic unit 28 during the execution of the first program. In a first instruction execution stage EX1 shown in (B1) of FIG. 6, the subtractor 31 receives the values of the registers r1 and r2: “0x00000100(=256)” and “0x00000080(=128)” shown in (C) and (D) of FIG. 6, and executes a subtraction “r1−r2”. The resultant difference “0x00000080” is retained in the temporary register 32, as shown in (F) of FIG. 6.

In a successive second instruction execution stage EX2, the selector 33 selects the data retained in the temporary register 32 and outputs the data to the multiplier 34, since the select signal A is at the H level. The multiplier 34 executes a multiplication according to the given data, and the product “0x00004000” is retained in the temporary register 35, as shown in (G) of FIG. 6.

In a third instruction execution stage EX3, the selector 36 selects the data retained in the temporary register 35 and outputs the data to the adder 37, since the select signal B is at the H level. The adder 37 adds the given data to the value of r3 “0x00000a00(=2560)” input from the register file unit 26, and the sum “0x00004a00” is stored in the register r3 in the register write back stage WB, through the pipeline registers 38 and 39. Also, as shown in (H) of FIG. 6, the sum is sent to the first arithmetic logic unit 27 as the bypass A output, and used for arithmetic operation processing in an instruction execution stage EX1 of the next instruction, as shown in (B2) of FIG. 6.

Thus, the “ZZZ” instruction, which is the additional instruction, is executed in the three cycles; the instruction execution stages EX1 to EX3, and as shown in (B2) of FIG. 6, an instruction execution stage ID of the next instruction is suspended for two stages.

### SECOND OPERATION EXAMPLE

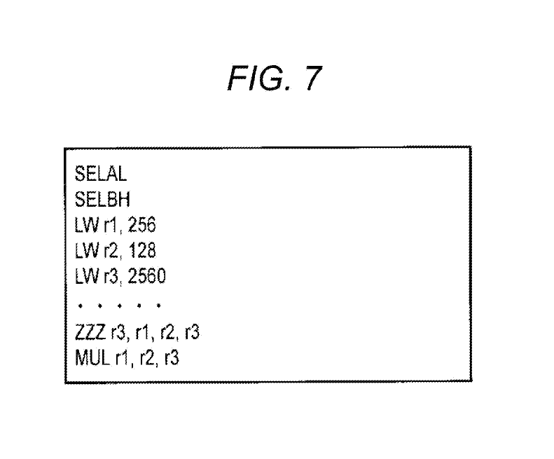

FIG. 7 is a diagram showing a second program example.

In the program, “SELAL” is an instruction to set the select signal A for the selector 33 at the L level, and “SELBH” is an instruction to set the select signal B for the selector 36 at the H level.

After the “LW” instruction, the second program example is executed in a similar manner to the first program example shown in FIG. 5.

In the case of this program, as described above, the select signal A is specified to be at the L level, and the select signal B to be at the H level. Therefore, as shown in FIG. 4, the instruction execution stage EX of the “ZZZ” instruction becomes two cycles.

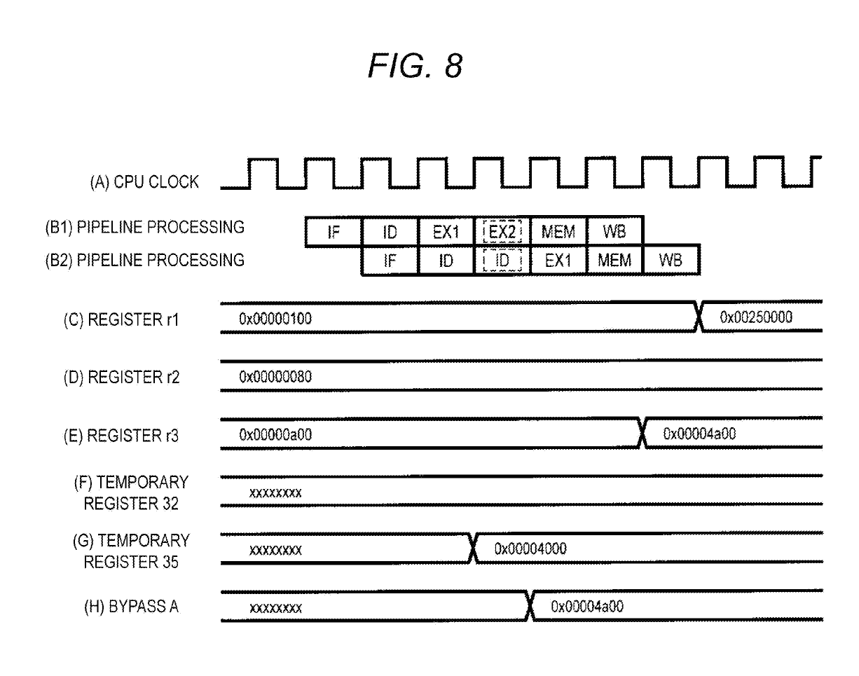

FIG. 8 is a timing chart showing contents of processing in the second arithmetic logic unit 28 during the execution of the second program. In a first instruction execution stage EX1 shown in (B1) of FIG. 8, the subtractor 31 receives the values of the registers r1 and r2: “0x00000100(=256)” and “0x00000080(=128)” shown in (C) and (D) of FIG. 8, and executes a subtraction “r1−r2”. Since the select signal A is at the L level, the selector 33 directly selects the difference “0x00000080” and outputs the difference to the multiplier 34. The multiplier 34 executes a multiplication according to the given data, and the product “0x00004000” is retained in the temporary register 35, as shown in (G) of FIG. 8.

In a successive second instruction execution stage EX2, the selector 36 selects the data retained in the temporary register 35 and outputs the data to the adder 37, since the select signal B is at the H level. The adder 37 adds the given data to the value of r3 “0x00000a00(=2560)” input from the register file unit 26, and the sum “0x00004a00” is stored in the register r3 in the register write back stage WB, through the pipeline registers 38 and 39. Also, as shown in (H) of FIG. 8, the sum is sent to the first arithmetic logic unit 27 as the bypass A output, and used for arithmetic operation processing in an instruction execution stage EX1 of the next instruction, as shown in (B2) of FIG. 8.

Thus, the “ZZZ” instruction, which is the additional instruction, is executed in the two cycles; the instruction execution stages EX1 and EX2, and as shown in (B2) of FIG. 8, an instruction execution stage ID of the next instruction is suspended for one stage.

### THIRD OPERATION EXAMPLE

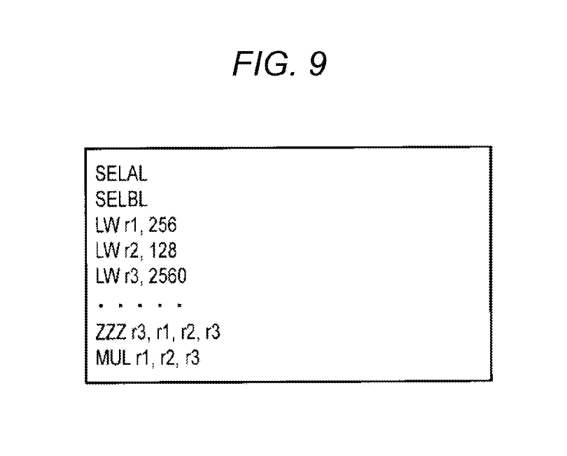

FIG. 9 is a diagram showing a third program example. In the program, “SELAL” is an instruction to set the select signal A for the selector 33 at the L level, and “SELBL” is an instruction to set the select signal B for the selector 36 at the L level.

After the “LW” instruction, the third program example is executed in a similar manner to the first program example shown in FIG. 5.

In the case of this program, as described above, both of the select signals A and B are specified to be at the L level. Therefore, as shown in FIG. 4, the instruction execution stage EX of the “ZZZ” instruction becomes one cycle.

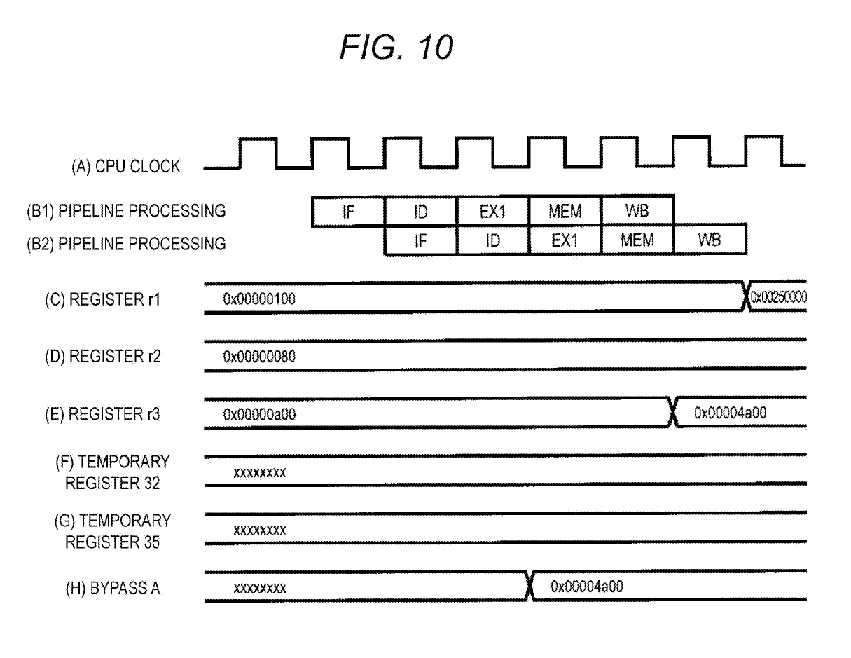

FIG. 10 is a timing chart showing contents of processing in the second arithmetic logic unit 28 during the execution of the third program. In a first instruction execution stage EX1 shown in (B1) of FIG. 10, the subtractor 31 receives the values of the registers r1 and r2: “0x00000100(=256)” and “0x00000080(=128)” shown in (C) and (D) of FIG. 10, and executes a subtraction “r1−r2”. Since the select signal A is at the L level, the selector 33 directly selects the difference “0x00000080” and outputs the difference to the multiplier 34. The multiplier 34 executes a multiplication according to the given data, and the product “0x00004000” is directly output to the selector 36.

Since the select signal B is at the L level, the selector 36 selects the output from the multiplier 34 and outputs the output to the adder 37. The adder 37 adds the given data to the value of r3 “0x00000a00(=2560)” input from the register file unit 26, and the sum “0x00004a00” is stored in the register r3 in the register write back stage WB, through the pipeline registers 38 and 39. Also, as shown in (H) of FIG. 10, the sum is sent to the first arithmetic logic unit 27 as the bypass A output, and used for arithmetic operation processing in an instruction execution stage EX1 of the next instruction, as shown in (B2) of FIG. 10.

Thus, the “ZZZ” instruction, which is the additional instruction, is executed in the one cycle; the instruction execution stage EX1. Therefore, there is no suspension in the next instruction, as shown in (B2) of FIG. 10.

As described above in detail, according to the present embodiment, the number of operation processing cycles for the additional instruction executed in the second arithmetic logic unit 28 is variable. As a result, the best processing cycle for each frequency can be achieved when the operation clock frequency of the CPU is changed.

Note that in the embodiment, the second arithmetic logic unit 28 has been described as an arithmetic logic unit dedicated for executing a particular arithmetic operation:

(a−b)*(a−b)+c. However, contents of the particular arithmetic operation executed by the second arithmetic logic unit 28, which is provided separately from the first arithmetic logic unit 27 executing, for example, simple four arithmetic operations and a logical operation, are not limited in the present invention. An arithmetic operation of any kind can be applied as long as it is executed by combining a plurality of arithmetic operation devices.

Besides, the present invention is not limited to the embodiment described above, and can be modified in various ways within the spirit and scope of the present invention. Also, functions executed in the embodiment described above can be combined when possible and needed. The embodiment described above includes various stages. According to the appropriate combinations of a plurality of elements disclosed herein, various embodiments of the invention may be extracted. For example, as long as the effect can be obtained, some elements may be eliminated from all the elements shown in the embodiment, and the configuration from which some of the elements have been eliminated can be extracted as the invention.

1. A microprocessor comprising:
an arithmetic operation unit including:
a plurality of arithmetic operation devices arranged in a multi-stage arrangement;
a delay device provided to each stage of the arithmetic operation devices excluding a final stage, and configured to delay an arithmetic operation result of the arithmetic operation devices for one cycle; and
a selector provided to each stage of the arithmetic operation devices excluding the final stage, and configured to select either the arithmetic operation result of the arithmetic operation devices or the arithmetic operation result delayed for one cycle in the delay device and output the selected result to the arithmetic operation device in a next stage,
the microprocessor being configured to collectively process a plurality of arithmetic operations from the arithmetic operation unit by controlling a selecting condition in the selector.

2. The microprocessor according to claim 1, wherein the arithmetic operation unit collectively processes a plurality of arithmetic operations in one instruction.

3. The microprocessor according to claim 2, wherein the arithmetic operation unit varies an operation processing cycle of one instruction by controlling a selecting condition in the selector.

4. The microprocessor according to claim 3, wherein the selector controls the selecting condition to increase the operation processing cycle of one instruction, when an operation frequency of the microprocessor is high.

5. The microprocessor according to claim 3, wherein the selector controls the selecting condition to decrease the operation processing cycle of one instruction, when an operation frequency of the microprocessor is low.

6. An arithmetic operation processing method of a microprocessor for collectively processing a plurality of arithmetic operations, comprising:
with respect to an arithmetic operation result of a plurality of arithmetic operation devices arranged in a multi-stage arrangement, generating a first arithmetic operation result which is the arithmetic operation result delayed for one cycle and a second arithmetic operation result which is the arithmetic operation result not delayed; and
selecting either the first arithmetic operation result or the second arithmetic operation result and inputting the selected result to the arithmetic operation device in a next stage.
